(19) United States
(12) Patent Application Publication
(10) Pub. No.: US 2005/0196154 A1
(43) Pub. Date: Sep. 8, 2005

(54) Portable DVD player with a USB transmission interface

(75) Inventors: Chi-Jui Chiang, Taipei City (TW); Chin-Mu Hsiao, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/989,269

(22) Filed: Nov. 17, 2004

(30) Foreign Application Priority Data
Mar. 8, 2004 (TW) 093106059

(51) Int. Cl. H04N 5/781

(52) U.S. Cl. 386/125; 386/126

(57) ABSTRACT

The portable DVD playing device with a USB transmission interface includes a DVD reader; a display; a USB transmission interface; and a CPU. When the USB transmission interface is connected to another electronic device with a USB transmission interface, the CPU controls the DVD player to transmit the data ion the disc to the another electronic device via the USB transmission interface; and when the USB transmission interface is not connected to the another electronic device with a USB transmission interface, the CPU controls the DVD player to play the images stored on the disk.

### BACKGROUND OF THE INVENTION

1. Field of the Invention

The present invention relates to a portable DVD player and, more particularly, to a portable DVD player with a USB transmission interface.

2. Description of the Related Art

Technological development has replaced the traditional family VCR with a DVD player, and the portable DVD player has become one of the most popular consumer video electronic products. The prior art portable DVD player only has a display capability without any real time reading capabilities, which is very inconvenient when it comes to Internet browsing.

Furthermore, in order to reduce the size, most notebook computers do not have an optical disk drive, which as a consequence must be purchased separately.

Therefore, it is desirable to provide a portable DVD player with a USB transmission interface to mitigate and/or obviate the aforementioned problems.

### SUMMARY OF THE INVENTION

A main objective of the present invention is to provide a portable DVD player with a USB transmission interface, which can perform data reading and transmission via the USB transmission interface.

Another objective of the present invention is to provide a portable DVD player with a USB transmission interface, which can display data read through the USB transmission interface on the display.

In order to achieve the above-mentioned objectives, the portable DVD player with a USB transmission interface of the present invention comprises: a DVD reader for reading data from a disc; a display for displaying the data; a USB transmission interface for connecting to an electronic device; and a CPU for controlling the DVD player to play images stored on the disc or to send the data stored on the disc to the USB transmission interface to transmit to the electronic device. When the USB transmission interface is connected to another electronic device with a USB transmission interface, the CPU controls the DVD player to transmit the data read from the disc to the another electronic device via the USB transmission interface.

When the CPU controls the DVD player, the data stored in the disc is transmitted to the electronic device via the USB transmission interface, and the data transmission status will been shown on the display of the DVD player.

The CPU is a single-chip processor which comprises a flag, and the flag is set when the USB transmission interface is connected to the other electronic device having a USB transmission interface, the flag otherwise being cleared.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment according to the present invention.

FIG. 2 is a functional block drawing of the embodiment according to the present invention.

FIG. 3 is a flow chart for the embodiment according to the present invention.

### DETAILED DESCRIPTION OF THE PREFERRED EMBODIMENT

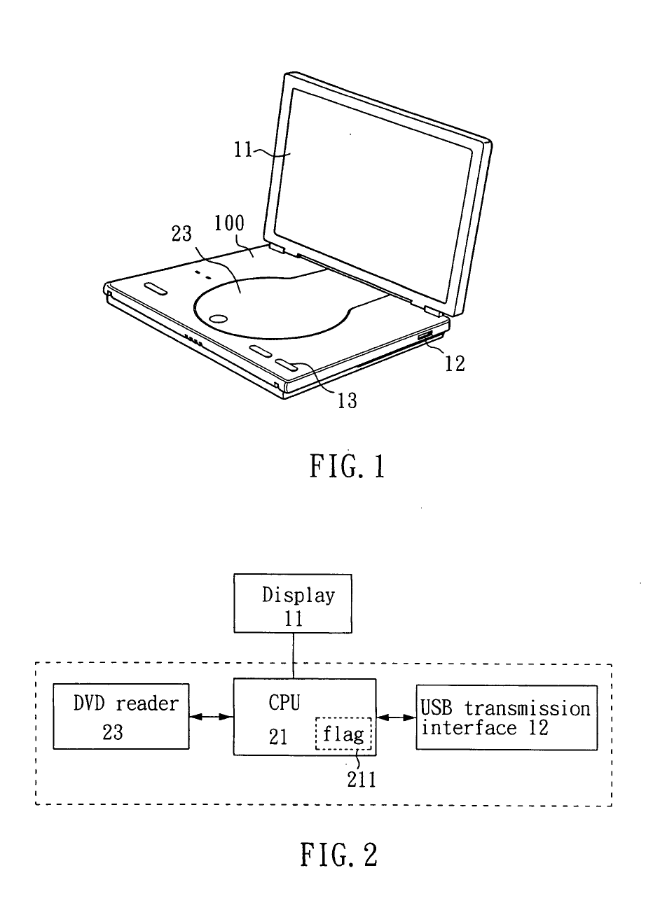

Please refer to FIG. 1 and FIG. 2. FIG. 1 is a perspective view of an embodiment according to the present invention. FIG. 2 is a functional block drawing of the embodiment according to the present invention. A portable DVD player 100 with a USB transmission interface 12 comprises a DVD reader 23, a display 11, and a CPU 21. In this embodiment, the CPU 21 is a single-chip processor; the single-chip processor comprises a flag 211, and the flag 211 is used to indicate if the USB transmission interface 12 is connected with another electronic device with USB transmission interface 101 (for example, a notebook) having a USB transmission interface. The flag 211 is set to indicate a connected status when the USB transmission interface is connected with another electronic device with USB transmission interface 101 having a USB transmission interface; otherwise the flag 211 is cleared.

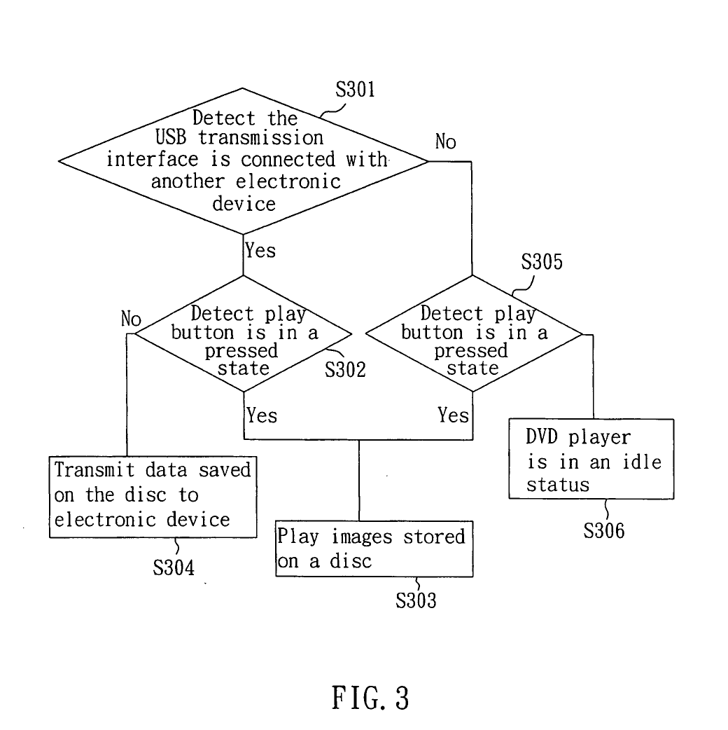

Please refer to FIG. 3. FIG. 3 is a flow chart for the embodiment according to the present invention. First, in step 301, the portable DVD player 100 detects if the USB transmission interface 12 is connected with another electronic device with USB transmission interface 101 having a USB transmission interface. If it is connected with another electronic device with USB transmission interface 101, the portable DVD player 100 further detects if a play button 13 is in a pressed state (step 302); if the play button 13 is in the pressed state, a DVD play functionality is executed to play images stored on a disc placed in the portable DVD player 100 (step 303); if the play button 13 is not in the pressed state, data transmission is performed between the portable DVD player 100 and another electronic device with USB transmission interface 101 via the USB transmission interface 12 (step 304). In step 305, the portable DVD player 100 further detects if the play button 13 is in the pressed state when the portable DVD player 100 is not connected to another electronic device with USB transmission n interface 101; if the play button 13 is in the pressed state, the DVD play functionality is executed to play images stored on the disc placed in the portable DVD player 100 (step 303); if the play button 13 is not in the pressed state, then the portable DVD player 100 is in an idle status (step 306).

In this embodiment, the CPU 21 controls the DVD play functionality of the portable DVD player 100 and the data transmission between the USB transmission interface 12 and another electronic device with USB transmission interface 101. When the USB transmission interface 12 is connected with another electronic device with USB transmission interface 101, the CPU 21 controls the portable DVD player 100 and transmits the data on the disk to another electronic device with USB transmission interface 101 via the USB transmission interface 12, and the data transmission is shown on the display 11. If the USB transmission interface 12 is not connected with another electronic device with USB transmission interface 101, the CPU 21 controls the portable DVD player 100 to play the images stored on the disk.

Although the present invention has been explained in relation to its preferred embodiment, it is to be understood that many other possible modifications and variations can be made without departing from the spirit and scope of the invention as hereinafter claimed.

1. A portable DVD player with a USB transmission interface comprising:
a DVD reader for reading data from a disc;
a display for displaying the data;
a USB transmission interface for connecting to an electronic device; and
a CPU for controlling the DVD player to play images stored on the disc or to send the data stored on the disc to the USB transmission interface to transmit to the electronic device.

2. The device as claimed in claim 1, wherein when the USB transmission interface is connected to another electronic device with a USB transmission interface, the CPU controls the DVD player to transmit the data on the disc to the other electronic device via the USB transmission interface; and when the USB transmission interface is not connected to the other electronic device having a USB transmission interface, the CPU controls the DVD player to play the images stored on the disc.

3. The device as claimed in claim 2, wherein when the CPU controls the DVD player to transmit the data on the disc to the other electronic device via the USB transmission interface, the display shows a data transmission status.

4. The device as claimed in claim 2, wherein the CPU is a single-chip processor.

5. The device as claimed in claim 4, wherein the single-chip processor comprises a flag, and the flag is set when the USB transmission interface is connected to the other electronic device with a USB transmission interface, the flag otherwise being cleared.

6. The device as claimed in claim 2, wherein the display is an LCD.

7. An operating method for a portable DVD player having a USB transmission interface, comprising the steps of:
(A) detecting if the USB transmission interface is connected to another electronic device with a USB transmission interface; if connected, when a play button is in a pressed state, a DVD play functionality is executed to play images stored on a disk placed in the portable DVD player; otherwise, step (B) is executed; and
(B) checking if the play button of the DVD player is in a pressed state; if in a pressed state, the DVD play functionality is executed to play images stored on a disc placed in the portable DVD player; if not in a pressed state, a data transmission procedure is performed between the portable DVD player and the other electronic device via the USB transmission interface.

8. The method as claimed in claim 5, wherein in step (B), when the data transmission procedure is performed between the portable DVD player and the other electronic device via the USB transmission interface, a data transmission status is shown on a display of the portable DVD player.
